(19) United States
(12) Patent Application Publication
(10) Pub. No.: US 2025/0239878 A1
(43) Pub. Date: Jul. 24, 2025

(54) BACKUP POWER SUPPLY SYSTEM AND SYNCHRONOUS SHUTDOWN METHOD

(71) Applicant: EVE ENERGY CO., LTD., Guangdong (CN)

(72) Inventor: Geng PENG, Guangdong (CN)

(21) Appl. No.: 19/089,580

(22) Filed: Mar. 25, 2025

Related U.S. Application Data
(63) Continuation of application No. PCT/CN2024/109106, filed on Aug. 1, 2024.

(30) Foreign Application Priority Data
Jan. 19, 2024 (CN) 202410079695.0

(51) Int. Cl. H02J 7/00; H01M 10/42; H01M 10/44

(52) U.S. Cl. CPC H02J 7/00712; H01M 10/425; H01M 10/441; H02J 7/00032; H02J 7/0013; H02J 7/0063

(57) ABSTRACT

Provided are a backup power supply system and a synchronous shutdown method. At least one of multiple battery backup units serves as a redundant power supply. The battery backup units are connected by a communication bus. The battery backup units share a discharge state through the communication bus. Each battery backup unit includes a synchronous shutdown circuit. Output terminals of synchronous shutdown circuits of the battery backup units are connected by a signal bus. When the number of battery backup units whose discharge states are stopping discharging is greater than the number of redundant power supplies, the output terminal of the synchronous shutdown circuit of any battery backup unit outputs a shutdown level signal, and each synchronous shutdown circuit controls all of the battery backup units to shut down synchronously in response to the shutdown level signal.

### CROSS-REFERENCE TO RELATED APPLICATIONS

This is a continuation of International Patent Application No. PCT/CN2024/109106, filed on Aug. 1, 2024, which claims priority to Chinese Patent Application No. 202410079695.0 filed with the China National Intellectual Property Administration (CNIPA) on Jan. 19, 2024, the disclosures of which are incorporated herein by reference in their entireties.

### TECHNICAL FIELD

The present application relates to power supply technologies, specifically a backup power supply system and a synchronous shutdown method.

### BACKGROUND

With the rapid development of the big data era, an increasing number of highly intelligent and high-performance computing data center power distribution systems have been deployed globally. The backup power supply system of a data center is a critical part. The synchronous shutdown signal processing mechanism for parallel battery backup units is required to have high reliability and stability while satisfying the system redundancy (2N or N+1) design requirements.

Currently, the processing methods of the synchronous shutdown signals of parallel battery backup units mainly fall into two categories. One category involves establishing a communication link between multiple parallel power supplies after they are connected in parallel and using communication data frames for identification. This method achieves synchronous shutdown of parallel power supplies under redundancy conditions. However, digital signals are prone to interference and delay, making it impossible to satisfy the requirements for simultaneous and rapid shutdown of multiple battery backup units.

### SUMMARY

According to a first aspect, the present application provides a backup power supply system. The backup power supply system includes multiple battery backup units. At least one battery backup unit of the backup power supply system serves as a redundant power supply. The battery backup units of the backup power supply system are connected by a communication bus and share a discharge state through the communication bus. Each battery backup unit includes a synchronous shutdown circuit. Output terminals of synchronous shutdown circuits of the battery backup units are connected by a signal bus. When the number of battery backup units whose discharge states are stopping discharging is greater than the number of redundant power supplies, the output terminal of the synchronous shutdown circuit of any battery backup unit outputs a shutdown level signal, and all the synchronous shutdown circuits control all of the battery backup units to shut down synchronously in response to the shutdown level signal.

In one or more embodiments, the synchronous shutdown circuit includes a main control chip, a switch unit, and a signal acquisition unit.

A signal output terminal of the main control chip is connected to a control terminal of the switch unit. A first terminal of the switch unit is connected to a reference power supply. A second terminal of the switch unit is grounded. An output terminal of the switch unit serves as the output terminal of the synchronous shutdown circuit.

An input terminal of the signal acquisition unit is connected to the output terminal of the switch unit. An output terminal of the signal acquisition unit is connected to the signal acquisition terminal of the main control chip.

Main control chips of the synchronous shutdown circuits are connected by the communication bus. Output terminals of switch units of the synchronous shutdown circuits are connected by the signal bus.

When the number of battery backup units whose discharge states are stopping discharging is greater than the number of redundant power supplies, the signal output terminal of the main control chip of the synchronous shutdown circuit of any battery backup unit outputs a first control signal to control the switch unit to turn on, the output terminal of the switch unit outputs the shutdown level signal, and the main control chip of each synchronous shutdown circuit controls each of the battery backup units to shut down synchronously through the shutdown level signal acquired by the signal acquisition unit.

In one or more embodiments, the switch unit includes a switch transistor and a voltage divider resistor. A first terminal of the voltage divider resistor is connected to the reference power supply. A second terminal of the voltage divider resistor is connected to a first terminal of the switch transistor. A second terminal of the switch transistor is grounded. A control terminal of the switch transistor is connected to the signal output terminal of the main control chip. The first terminal of the switch transistor serves as the output terminal of the switch unit.

In one or more embodiments, the signal acquisition unit includes an acquisition resistor. A first terminal of the acquisition resistor is connected to the output terminal of the switch unit. A second terminal of the acquisition resistor is connected to the signal acquisition terminal of the main control chip.

In one or more embodiments, the communication bus is a controller area network (CAN) bus, a local area network (LAN) bus, or a Modicon's bus (MODBUS).

According to a second aspect, the present application provides a synchronous shutdown method of a battery backup unit. The synchronous shutdown method is based on the backup power supply system of the present application.

The synchronous shutdown method includes, when a target battery backup unit stops discharging, the discharge state of stopping discharging is reported through the communication bus to the other battery backup units; whether the number of battery backup units whose current discharge states are stopping discharging is greater than the number of redundant power supplies is determined by any battery backup unit; and when the number of battery backup units whose discharge states are stopping discharging is greater than the number of redundant power supplies, the output terminal of the synchronous shutdown circuit of any battery backup unit outputs a shutdown level signal, and each synchronous shutdown circuits controls each of the battery backup units to shut down synchronously in response to the shutdown level signal.

In one or more embodiments, the synchronous shutdown method also includes, when the number of battery backup units whose discharge states are stopping discharging is less than or equal to the number of redundant power supplies, it is returned to the step of determining, by any battery backup unit, whether the number of battery backup units whose current discharge states are stopping discharging is greater than the number of redundant power supplies.

In one or more embodiments, the synchronous shutdown method also includes, when the discharge duration of the target battery backup unit exceeds a preset duration, or when the target battery backup unit is overloaded, or when the target battery backup unit receives an external discharge stop command, the target battery backup unit stops discharging and reports the discharge state of stopping discharging to the other battery backup units through the communication bus.

In one or more embodiments, after the synchronous shutdown circuits control all of the battery backup units to shut down synchronously in response to the shutdown level signal, the synchronous shutdown method also includes resetting a level signal of the output terminal of each of the synchronous shutdown circuits to reset the discharge states of the battery backup units.

In one or more embodiments, after the discharge states of the battery backup units are reset, the synchronous shutdown method also includes, after replacing a battery backup unit, determining whether the number of battery backup units whose current discharge states are stopping discharging is zero; and when the number of battery backup units whose current discharge states are stopping discharging is zero, controlling all of the battery backup units to stop sending messages to the communication bus; or when the number of battery backup units whose current discharge states are stopping discharging is not zero, continuously reporting, by the battery backup units whose current discharge states are stopping discharging, through the communication bus, the discharge state of stopping discharging to the other battery backup units, and returning to the step of determining, by any battery backup unit, whether the number of battery backup units whose current discharge states are stopping discharging is greater than the number of redundant power supplies.

The backup power supply system of the present application includes multiple battery backup units. At least one battery backup unit of the backup power supply system serves as a redundant power supply. The battery backup units are connected by a communication bus. The battery backup units share a discharge state through the communication bus. Each battery backup unit includes a synchronous shutdown circuit. Output terminals of synchronous shutdown circuits of the battery backup units are connected by a signal bus. When the number of battery backup units whose discharge states are stopping discharging is greater than the number of redundant power supplies, the output terminal of the synchronous shutdown circuit of any battery backup unit outputs a shutdown level signal, and each synchronous shutdown circuit controls each of the battery backup units to shut down synchronously in response to the shutdown level signal. In the present application, the synchronous shutdown circuit outputs the shutdown level signal to achieve synchronous shutdown of the multiple battery backup units of the backup power supply system, avoiding interference with and delay of digital signals and improving the stability and shutdown response speed of the backup power supply system.

### BRIEF DESCRIPTION OF THE DRAWINGS

FIG. 1 is a diagram illustrating the structure of a backup power supply system according to an embodiment of the present application.

FIG. 2 is a circuit diagram of a synchronous shutdown circuit of a battery backup unit.

FIG. 3 is a circuit diagram illustrating connection of a synchronous shutdown circuit of a battery backup unit.

FIG. 4 is a flowchart of a synchronous shutdown method of a battery backup unit according to an embodiment of the present application.

### DETAILED DESCRIPTION

Solutions in the present application will be described below in detail in conjunction with the drawings. The embodiments described below are part, not all of the embodiments of the present application.

In the description of the present application, unless otherwise expressly specified and limited, the term “connected to each other”, “connected”, or “fixed” is to be construed in a broad sense, for example, as fixedly connected, detachably connected, or integrated; mechanically connected or electrically connected; directly connected to each other or indirectly connected to each other via an intermediary; or internally connected between two elements or interaction relations between two elements. For those of ordinary skill in the art, specific meanings of the preceding terms in the present application may be understood based on specific situations.

In the present application, unless otherwise specified and limited, when a first feature is described as “on” or “below” a second feature, the first feature and the second feature may be in direct contact or be in contact via another feature between the two features instead of being in direct contact. Moreover, when the first feature is described as “on”, “above”, or “over” the second feature, the first feature is right on, above, or over the second feature, or the first feature is obliquely on, above, or over the second feature, or the first feature is simply at a higher level than the second feature. When the first feature is described as “under”, “below”, or “underneath” the second feature, the first feature is right under, below, or underneath the second feature, or the first feature is obliquely under, below, or underneath the second feature, or the first feature is simply at a lower level than the second feature. In addition, terms “first” and “second” are used only for distinguishing between descriptions and have no special meaning.

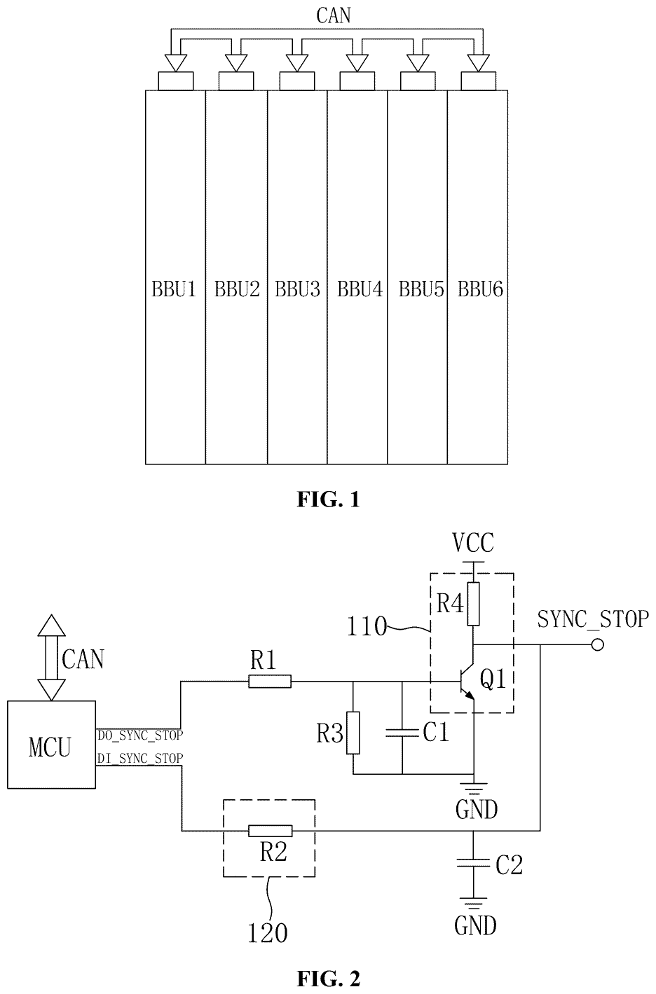

FIG. 1 is a diagram illustrating the structure of a backup power supply system according to an embodiment of the present application. FIG. 2 is a circuit diagram of a synchronous shutdown circuit of a battery backup unit. As shown in FIG. 1 and FIG. 2, the backup power supply system includes multiple battery backup units (BBUs). At least one battery backup unit serves as a redundant power supply. The backup power supply system is configured to start to temporarily supply power to an electrical device when the power supply bus cannot supply power normally. For example, the battery backup units may be connected in parallel when supplying power to the electrical device. The redundant power supply may serve as a backup to replace a faulty battery backup unit when other battery backup units malfunction. The battery backup units are connected by a communication bus. The battery backup units share a discharge state through the communication bus. That is, a battery backup unit reports its own discharge state to other battery backup units through the communication bus. For example, as shown in FIG. 1, this embodiment is described using an example in which the backup power supply system includes six battery backup units and one of the battery backup units serves a redundant power supply. The communication bus may be a CAN bus, a LAN bus, or a MODBUS. This is not limited in this embodiment of the present application. By way of example, in FIG. 1 and FIG. 2, the description is made using an example in which the communication bus is a CAN bus.

Each battery backup unit includes a synchronous shutdown circuit. Output terminals of synchronous shutdown circuits of all of the battery backup units are connected by a signal bus 130.

When the backup power supply system supplies power normally, the battery backup units supply power to the electrical device simultaneously, and the backup power supply system does not trigger synchronous shutdown. A battery backup unit reports its own discharge state to the other battery backup units through the communication bus. When the number of battery backup units whose discharge states are stopping discharging is greater than the number of redundant power supplies, that is, when the output voltage of the backup power supply system cannot satisfy the normal operation of the electrical device, the backup power supply system should be shut down in time to avoid overload and damage of the backup power supply system or under-voltage failure of the electrical device. At this time, the output terminal of the synchronous shutdown circuit of any battery backup unit outputs a shutdown level signal. Since the output terminals of the synchronous shutdown circuits of all of the battery backup units are connected by the signal bus 130, the output terminals of the synchronous shutdown circuits of all of the battery backup units output the shutdown level signal, and each synchronous shutdown circuit controls all of the battery backup units to shut down synchronously in response to the shutdown level signal. In this embodiment of the present application, the synchronous shutdown circuit outputs the shutdown level signal to achieve synchronous shutdown of the battery backup units of the backup power supply system, avoiding interference with and delay of digital signals and improving the stability and shutdown response speed of the backup power supply system.

The backup power supply system of this embodiment in the present application includes multiple battery backup units. At least one battery backup unit of the multiple battery backup units serves as a redundant power supply. The multiple battery backup units are connected by a communication bus. The multiple battery backup units share a discharge state through the communication bus. Each battery backup unit includes a synchronous shutdown circuit. Output terminals of synchronous shutdown circuits of the battery backup units are connected by a signal bus 130. When the number of battery backup units whose discharge states are stopping discharging is greater than the number of redundant power supplies, the output terminal of the synchronous shutdown circuit of any battery backup unit outputs a shutdown level signal, and each synchronous shutdown circuit controls all of the battery backup units to shut down synchronously in response to the shutdown level signal. In the present application, the synchronous shutdown circuit outputs the shutdown level signal to achieve synchronous shutdown of the multiple battery backup units in the backup power supply system, avoiding interference with and delay of digital signals and improving the stability and shutdown response speed of the backup power supply system.

In some embodiments of the present application, as shown in FIG. 2, the synchronous shutdown circuit includes a main control chip (microcontroller unit (MCU)), a switch unit 110, and a signal acquisition unit 120. The signal output terminal DO_SYNC_STOP of the main control chip (MCU) is connected to the control terminal of the switch unit 110. A first terminal of the switch unit 110 is connected to a reference power supply VCC. A second terminal of the switch unit 110 is grounded. The output terminal SYNC_STOP of the switch unit 110 serves as the output terminal of the synchronous shutdown circuit.

The input terminal of the signal acquisition unit 120 is connected to the output terminal SYNC_STOP of the switch unit 110. The output terminal of the signal acquisition unit 120 is connected to the signal acquisition terminal DI_SYNC_STOP of the main control chip (MCU).

Main control chips (MCUs) of the synchronous shutdown circuits are connected by the communication bus (CAN bus). Output terminals SYNC_STOP of the switch units 110 of the synchronous shutdown circuits are connected by the signal bus 130.

A battery backup unit reports its own discharge state to other battery backup units through the communication bus. When the number of battery backup units whose discharge states are stopping discharging is greater than the number of redundant power supplies, the signal output terminal DO_SYNC_STOP of the main control chip (MCU) of the synchronous shutdown circuit in any battery backup unit outputs a first control signal to control the switch unit 110 to turn on, the switch unit 110 is grounded, and the output terminal SYNC_STOP of the switch unit 110 outputs a shutdown level signal (low level). Moreover, since output terminals SYNC_STOP of the synchronous shutdown circuits of all of the battery backup units are connected by the signal bus 130, output terminals SYNC_STOP of synchronous shutdown circuits of all of the battery backup units are pulled down to a low level, and the main control chip (MCU) of each synchronous shutdown circuit controls all of the battery backup units to shut down synchronously through the shutdown level signal acquired by the signal acquisition unit 120.

In some embodiments of the present application, as shown in FIG. 2, the switch unit 110 includes a switch transistor Q1 and a voltage divider resistor R4. A first terminal of the voltage divider resistor R4 is connected to the reference power supply VCC. A second terminal of the voltage divider resistor R4 is connected to a first terminal of the switch transistor Q1. A second terminal of the switch transistor Q1 is grounded. The control terminal of the switch transistor Q1 is connected to the signal output terminal DO_SYNC_STOP of the main control chip (MCU). The first terminal of the switch transistor Q1 serves as the output terminal SYNC_STOP of the switch unit 110. The voltage divider resistor R4 functions as a voltage divider.

For example, as shown in FIG. 2, the signal acquisition unit 120 includes an acquisition resistor R2. A first terminal of the acquisition resistor R2 is connected to the output terminal SYNC_STOP of the switch unit 110. A second terminal of the acquisition resistor R2 is connected to the signal acquisition terminal DI_SYNC_STOP of the main control chip (MCU).

For example, when the backup power supply system supplies power normally, the battery backup units supply power to the electrical device simultaneously, and the backup power supply system does not trigger synchronous shutdown. At this time, the signal output terminal DO_SYNC_STOP of the main control chip (MCU) of the synchronous shutdown circuit of each battery backup unit outputs a second control signal (low level) to control the switch transistor Q1 to shut down, the first terminal of the switch transistor Q1 outputs a high level, and the battery backup units keep working.

A battery backup unit reports its own discharge state to other battery backup units through the communication bus. When the number of battery backup units whose discharge states are stopping discharging is greater than the number of redundant power supplies, the signal output terminal DO_SYNC_STOP of the main control chip (MCU) of the synchronous shutdown circuit of any battery backup unit outputs a first control signal (high level) to control the switch transistor Q1 to turn on, and the level of the first terminal SYNC_STOP of the switch transistor Q1 is pulled to a low level. Moreover, since the output terminals SYNC_STOP of the synchronous shutdown circuits in all of the battery backup units are connected by the signal bus 130, the output terminals SYNC_STOP of the synchronous shutdown circuits in all of the battery backup units are pulled down to a low level, and the main control chip (MCU) of each synchronous shutdown circuit controls all of the battery backup units to shut down synchronously through the shutdown level signal (low level) acquired by the acquisition resistor R2.

For example, as shown in FIG. 2, in some embodiments of the present application, the control terminal of the switch transistor Q1 is connected to the signal output terminal DO_SYNC_STOP of the main control chip (MCU) by a current-limiting resistor R1. The current-limiting resistor R1 serves to limit the current, preventing an excessive peak current from damaging the switch transistor Q1.

For example, as shown in FIG. 2, in some embodiments of the present application, the control terminal and the second terminal of the switch transistor Q1 are connected to a resistor R3 and a capacitor C1. A first terminal of the resistor R3 is connected to the control terminal of the switch transistor Q1. A second terminal of the resistor R3 is connected to the second terminal of the switch transistor Q1. A first terminal of the capacitor C1 is connected to the control terminal of the switch transistor Q1. A second terminal of the capacitor C1 is connected to the second terminal of the switch transistor Q1. The resistor R3 and the capacitor C1 serve to discharge static electricity to prevent the switch transistor Q1 from being broken down due to accumulation of static electricity.

For example, as shown in FIG. 2, in some embodiments of the present application, the first terminal of the acquisition resistor R2 is also connected to a capacitor C2. A first terminal of the capacitor C2 is connected to the first terminal of the acquisition resistor R2. A second terminal of the capacitor C2 is grounded. The capacitor C2 serves to filter out an interference signal to ensure the accuracy of a level acquired by the main control chip (MCU).

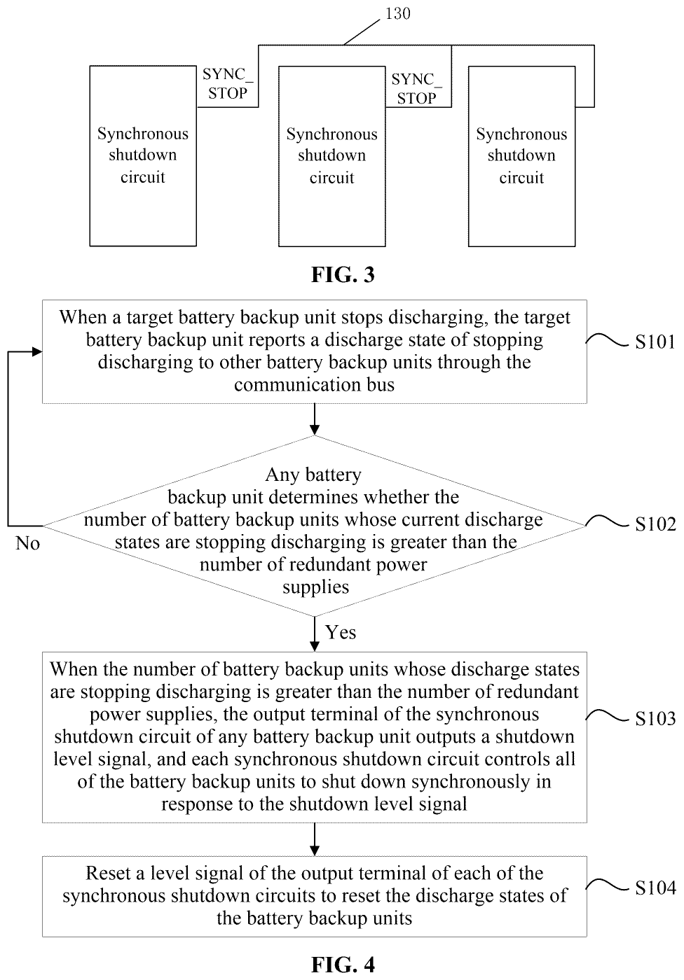

An embodiment of the present application also provides a synchronous shutdown method of a battery backup unit. The method is based on the backup power supply system of any previous embodiment of the present application. FIG. 4 is a flowchart of a synchronous shutdown method of a battery backup unit according to an embodiment of the present application. The method includes the following steps:

In S101, when a target battery backup unit stops discharging, a discharge state of stopping discharging is reported to other battery backup units through the communication bus.

When the backup power supply system supplies power normally, the battery backup units supply power to the electrical device simultaneously, and the backup power supply system does not trigger synchronous shutdown. When the target battery backup unit stops discharging, the discharge state of stopping discharging is reported to other battery backup units through the communication bus. For example, the discharge state of stopping discharging is represented by “1”, and the discharge state of being discharging is represented by “0”. A battery backup unit reports its own discharge state to other battery backup units through the communication bus. In this embodiment of the present application, a battery backup unit does not periodically report its own discharge state through the communication bus. Rather, a battery backup unit reports its own discharge state to other battery backup units through the communication bus when the target battery backup unit stops discharging. That is, timed reporting is changed to event-driven reporting, thereby reducing the burden on the communication bus.

For example, the condition for the target battery backup unit to stop discharging includes that the discharge duration of the target battery backup unit exceeds a preset duration, the target battery backup unit is overloaded, and the target battery backup unit receives an external discharge stop command. When the discharge duration of the target battery backup unit exceeds a preset duration, or the target battery backup unit is overloaded, or the target battery backup unit receives an external discharge stop command, the target battery backup unit stops discharging and reports the discharge state of stopping discharging to other battery backup units through the communication bus.

In S102, any battery backup unit determines whether the number of battery backup units whose current discharge states are stopping discharging is greater than the number of redundant power supplies.

For example, any battery backup unit determines whether the number of battery backup units whose current discharge states are stopping discharging is greater than the number of redundant power supplies. For example, as shown in FIG. 1, this embodiment is described using an example in which the backup power supply system includes six battery backup units and one of the battery backup units serves as a redundant power supply. In this case, any battery backup unit determines whether the number of battery backup units whose current discharge states are stopping discharging is greater than 1.

In S103, when the number of battery backup units whose discharge states are stopping discharging is greater than the number of redundant power supplies, the output terminal of the synchronous shutdown circuit of any battery backup unit outputs a shutdown level signal, and each synchronous shutdown circuit controls all of the battery backup units to shut down synchronously in response to the shutdown level signal.

For example, when the number of battery backup units whose discharge states are stopping discharging is greater than the number of redundant power supplies, that is, when the output voltage of the backup power supply system cannot satisfy the normal operation of the electrical device, the backup power supply system should be shut down in time to avoid overload and damage of the backup power supply system or under-voltage failure of the electrical device. At this time, the output terminal of the synchronous shutdown circuit of any battery backup unit outputs a shutdown level signal. Since the output terminals of the synchronous shutdown circuits in all of the battery backup units are connected by the signal bus 130, the output terminals of the synchronous shutdown circuits in all of the battery backup units are the shutdown level signal, and each synchronous shutdown circuit controls all of the battery backup units to shut down synchronously in response to the shutdown level signal. In this embodiment of the present application, the synchronous shutdown circuit outputs the shutdown level signal to achieve synchronous shutdown of the battery backup units of the backup power supply system, avoiding interference with and delay of digital signals and improving the stability and shutdown response speed of the backup power supply system.

For example, referring to FIG. 2, when the backup power supply system supplies power normally, the battery backup units supply power to the electrical device simultaneously, and the backup power supply system does not trigger synchronous shutdown. At this time, the signal output terminal DO_SYNC_STOP of the main control chip (MCU) of the synchronous shutdown circuit in each battery backup unit outputs a second control signal (low level) to control the switch transistor Q1 to shut down, the first terminal of the switch transistor Q1 outputs a high level, and the battery backup units keep working.

A battery backup unit reports its own discharge state to other battery backup units through the communication bus. When the number of battery backup units whose discharge states are stopping discharging is greater than the number of redundant power supplies, the signal output terminal DO_SYNC_STOP of the main control chip (MCU) of the synchronous shutdown circuit in any battery backup unit outputs a first control signal (high level) to control the switch transistor Q1 to turn on, and the level of the first terminal SYNC_STOP of the switch transistor Q1 is pulled to a low level. Moreover, since the output terminals SYNC_STOP of the synchronous shutdown circuits in all of the battery backup units are connected by the signal bus 130, the output terminals SYNC_STOP of the synchronous shutdown circuits in all of the battery backup units are pulled down to a low level, and the main control chip (MCU) of each synchronous shutdown circuit controls all of the battery backup units to shut down synchronously through the shutdown level signal (low level) acquired by the acquisition resistor R2.

For example, as shown in FIG. 4, in some embodiments of the present application, when the number of battery backup units whose discharge states are stopping discharging is less than or equal to the number of redundant power supplies, the process returns to the operation that any battery backup unit determines whether the number of battery backup units whose current discharge states are stopping discharging is greater than the number of redundant power supplies until the number of battery backup units whose discharge states are stopping discharging is greater than the number of redundant power supplies.

In some embodiments of the present application, as shown in FIG. 4, after each synchronous shutdown circuit controls all of the battery backup units to shut down synchronously in response to the shutdown level signal, the synchronous shutdown method also includes the following:

In S104, a level signal of the output terminal of each of the synchronous shutdown circuits is reset so that the discharge state of each of the battery backup units is reset.

In this embodiment of the present application, after each synchronous shutdown circuit controls all of the battery backup units to shut down synchronously in response to the shutdown level signal, the level signal of the output terminal of each of the synchronous shutdown circuits is reset so that the discharge state of each battery backup unit is reset.

For example, referring to FIG. 2, after each synchronous shutdown circuit controls all of the battery backup units to shut down synchronously in response to the shutdown level signal, the signal output terminal DO_SYNC_STOP of the main control chip (MCU) of each synchronous shutdown circuit outputs a second control signal (low level) to control the switch transistor Q1 to shut down, the first terminal of the switch transistor Q1 recovers to a high level, and the discharge states of the battery backup units are reset to “0” to prepare for the subsequent operation of the backup power supply system.

In some embodiments of the present application, after resetting (clearing) the discharge states of the battery backup units, the method also includes replacing a battery backup unit that cannot discharge normally and then determining whether the number of battery backup units whose current discharge states are stopping discharging is zero; if yes, it indicates that all of the battery backup units are normal, and all of the battery backup units stop sending messages to the communication bus to reduce the burden on the communication bus; and if not, the battery backup units whose current discharge states are stopping discharging continuously report, through the communication bus, the discharge state of stopping discharging to other battery backup units, and the process returns to the operation that any battery backup unit determines whether the number of battery backup units whose current discharge states are stopping discharging is greater than the number of redundant power supplies.

In the description of the present application, it is to be understood that the orientation or position relationships indicated by terms “above”, “below”, “left”, “right” and the like are based on the orientation or position relationships shown in the drawings, merely for facilitating description and simplifying operation, and these relationships do not indicate or imply that the referred device or element has a specific orientation and is constructed and operated in a specific orientation, and thus it is not to be construed as limiting the present application.

In the description of the specification, the description of reference terms “an embodiment” or “example” means that specific characteristics, structures, materials, or features described in connection with the embodiment or example are included in at least one embodiment or example of the present application. In the specification, the illustrative description of the preceding terms does not necessarily refer to the same embodiment or example.

Moreover, although this specification is described in terms of embodiments, not each embodiment includes only one independent technical solution. Such description mode of the specification is merely for the sake of clarity, and those skilled in the art should regard the specification as a whole. The technical solutions in multiple embodiments may also be appropriately combined to form other embodiments which will be understood by those skilled in the art.

What is claimed is:

1. A backup power supply system, comprising a plurality of battery backup units, wherein
at least one of the plurality of battery backup units serves as a redundant power supply, the plurality of battery backup units are connected by a communication bus, and the plurality of battery backup units share a discharge state through the communication bus;
each of the plurality of battery backup units comprises a synchronous shutdown circuit, and output terminals of synchronous shutdown circuits of the plurality of battery backup units are connected by a signal bus; and
in response to a number of battery backup units whose discharge states are stopping discharging being greater than a number of redundant power supplies, an output terminal of the synchronous shutdown circuit in any of the plurality of battery backup units outputs a shutdown level signal, and each of the synchronous shutdown circuits controls all of the plurality of battery backup units to shut down synchronously in response to the shutdown level signal.

2. The backup power supply system of claim 1, wherein
the synchronous shutdown circuit comprises a main control chip, a switch unit, and a signal acquisition unit;
a signal output terminal of the main control chip is connected to a control terminal of the switch unit, a first terminal of the switch unit is connected to a reference power supply, a second terminal of the switch unit is grounded, and an output terminal of the switch unit serves as an output terminal of the synchronous shutdown circuit;
an input terminal of the signal acquisition unit is connected to the output terminal of the switch unit, and an output terminal of the signal acquisition unit is connected to a signal acquisition terminal of the main control chip;
main control chips of the synchronous shutdown circuits are connected by the communication bus, and output terminals of switch units of the synchronous shutdown circuits are connected by the signal bus; and
in response to the number of battery backup units whose discharge states are stopping discharging being greater than the number of redundant power supplies, the signal output terminal of the main control chip of the synchronous shutdown circuit in any of the plurality of battery backup units outputs a first control signal to control the switch unit to turn on, the output terminal of the switch unit outputs the shutdown level signal, and the main control chip of each of the synchronous shutdown circuits controls all of the plurality of battery backup units to shut down synchronously through the shutdown level signal acquired by the signal acquisition unit.

3. The backup power supply system of claim 2, wherein the switch unit comprises a switch transistor and a voltage divider resistor, a first terminal of the voltage divider resistor is connected to the reference power supply, a second terminal of the voltage divider resistor is connected to a first terminal of the switch transistor, a second terminal of the switch transistor is grounded, a control terminal of the switch transistor is connected to the signal output terminal of the main control chip, and the first terminal of the switch transistor serves as the output terminal of the switch unit.

4. The backup power supply system of claim 2, wherein the signal acquisition unit comprises an acquisition resistor, a first terminal of the acquisition resistor is connected to the output terminal of the switch unit, and a second terminal of the acquisition resistor is connected to the signal acquisition terminal of the main control chip.

5. The backup power supply system of claim 3, wherein the signal acquisition unit comprises an acquisition resistor, a first terminal of the acquisition resistor is connected to the output terminal of the switch unit, and a second terminal of the acquisition resistor is connected to the signal acquisition terminal of the main control chip.

6. The backup power supply system of claim 1, wherein the communication bus is a controller area network (CAN) bus, a local area network (LAN) bus, or a Modicon's bus (MODBUS).

7. The backup power supply system of claim 2, wherein the communication bus is a controller area network (CAN) bus, a local area network (LAN) bus, or a Modicon's bus (MODBUS).

8. The backup power supply system of claim 3, wherein the communication bus is a controller area network (CAN) bus, a local area network (LAN) bus, or a Modicon's bus (MODBUS).

9. A synchronous shutdown method of a battery backup unit, wherein the backup power supply system comprises a plurality of battery backup units, at least one of the plurality of battery backup units serves as a redundant power supply, the plurality of battery backup units are connected by a communication bus, and the plurality of battery backup units share a discharge state through the communication bus;
each of the plurality of battery backup units comprises a synchronous shutdown circuit, and output terminals of synchronous shutdown circuits of the plurality of battery backup units are connected by a signal bus; and
in response to a number of battery backup units whose discharge states are stopping discharging being greater than a number of redundant power supplies, an output terminal of the synchronous shutdown circuit in any of the plurality of battery backup units outputs a shutdown level signal, and each of the synchronous shutdown circuits controls all of the plurality of battery backup units to shut down synchronously in response to the shutdown level signal; and
the method comprises:
in response to a target battery backup unit of the plurality of battery backup units stopping discharging, reporting, through the communication bus, a discharge state of stopping discharging to other battery backup units of the plurality of battery backup units;
determining, by any of the plurality of battery backup units, whether the number of battery backup units whose current discharge states are stopping discharging is greater than the number of redundant power supplies; and
in response to the number of battery backup units whose discharge states are stopping discharging being greater than the number of redundant power supplies, controlling the output terminal of the synchronous shutdown circuit in any of the plurality of battery backup units to output the shutdown level signal and controlling, by each of the synchronous shutdown circuits, all of the plurality of battery backup units to shut down synchronously in response to the shutdown level signal.

10. The synchronous shutdown method of claim 9, further comprising:
in response to the number of battery backup units whose discharge states are stopping discharging being less than or equal to the number of redundant power supplies, returning to determining, by any of the plurality of battery backup units, whether the number of battery backup units whose current discharge states are stopping discharging is greater than the number of redundant power supplies.

11. The synchronous shutdown method of claim 9, further comprising:
in response to a discharge duration of the target battery backup unit exceeding a preset duration, or in response to the target battery backup unit being overloaded, or in response to the target battery backup unit receiving an external discharge stop command, controlling the target battery backup unit to stop discharging and reporting the discharge state of stopping discharging to the other battery backup units through the communication bus.

12. The synchronous shutdown method of claim 9, wherein after controlling, by each of the synchronous shutdown circuits, all of the plurality of battery backup units to shut down synchronously in response to the shutdown level signal, the method further comprises:
resetting a level signal of the output terminal of each of the synchronous shutdown circuits to reset a discharge state of each of the plurality of battery backup units.

13. The synchronous shutdown method of claim 10, wherein after controlling, by each of the synchronous shutdown circuits, all of the plurality of battery backup units to shut down synchronously in response to the shutdown level signal, the method further comprises:
resetting a level signal of the output terminal of each of the synchronous shutdown circuits to reset a discharge state of each of the plurality of battery backup units.

14. The synchronous shutdown method of claim 11, wherein after controlling, by each of the synchronous shutdown circuits, all of the plurality of battery backup units to shut down synchronously in response to the shutdown level signal, the method further comprises:
resetting a level signal of the output terminal of each of the synchronous shutdown circuits to reset a discharge state of each of the plurality of battery backup units.

15. The synchronous shutdown method of claim 12, wherein after resetting the discharge state of each of the plurality of battery backup units, the method further comprises:
after replacing a battery backup unit, determining whether the number of battery backup units whose current discharge states are stopping discharging is zero; and
in response to the number of battery backup units whose current discharge states are stopping discharging being zero, controlling all of the plurality of battery backup units to stop sending messages to the communication bus; or
in response to the number of battery backup units whose current discharge states are stopping discharging being non-zero, continuously reporting, by the battery backup units whose current discharge states are stopping discharging, the discharge states of stopping discharging to other battery backup units through the communication bus, and returning to determining, by any of the plurality of battery backup units, whether the number of battery backup units whose current discharge states are stopping discharging is greater than the number of redundant power supplies.

16. The synchronous shutdown method of claim 9, wherein
the synchronous shutdown circuit comprises a main control chip, a switch unit, and a signal acquisition unit;
a signal output terminal of the main control chip is connected to a control terminal of the switch unit, a first terminal of the switch unit is connected to a reference power supply, a second terminal of the switch unit is grounded, and an output terminal of the switch unit serves as an output terminal of the synchronous shutdown circuit;
an input terminal of the signal acquisition unit is connected to the output terminal of the switch unit, and an output terminal of the signal acquisition unit is connected to a signal acquisition terminal of the main control chip;
main control chips of the synchronous shutdown circuits are connected by the communication bus, and output terminals of switch units of the synchronous shutdown circuits are connected by the signal bus; and
in response to the number of battery backup units whose discharge states are stopping discharging being greater than the number of redundant power supplies, the signal output terminal of the main control chip of the synchronous shutdown circuit in any of the plurality of battery backup units outputs a first control signal to control the switch unit to turn on, the output terminal of the switch unit outputs the shutdown level signal, and the main control chip of each of the synchronous shutdown circuits controls all of the plurality of battery backup units to shut down synchronously through the shutdown level signal acquired by the signal acquisition unit.

17. The synchronous shutdown method of claim 16, wherein the switch unit comprises a switch transistor and a voltage divider resistor, a first terminal of the voltage divider resistor is connected to the reference power supply, a second terminal of the voltage divider resistor is connected to a first terminal of the switch transistor, a second terminal of the switch transistor is grounded, a control terminal of the switch transistor is connected to the signal output terminal of the main control chip, and the first terminal of the switch transistor serves as the output terminal of the switch unit.

18. The synchronous shutdown method of claim 16, wherein the signal acquisition unit comprises an acquisition resistor, a first terminal of the acquisition resistor is connected to the output terminal of the switch unit, and a second terminal of the acquisition resistor is connected to the signal acquisition terminal of the main control chip.

19. The synchronous shutdown method of claim 17, wherein the signal acquisition unit comprises an acquisition resistor, a first terminal of the acquisition resistor is connected to the output terminal of the switch unit, and a second terminal of the acquisition resistor is connected to the signal acquisition terminal of the main control chip.

20. The synchronous shutdown method of claim 9, wherein the communication bus is a controller area network (CAN) bus, a local area network (LAN) bus, or a Modicon's bus (MODBUS).
